(19) United States
(12) Patent Application Publication
(10) Pub. No.: US 2013/0125096 A1
(43) Pub. Date: May 16, 2013

(54) Systems and Methods for Dynamic Collection of Probe Call Sites

(71) Applicants: André Kruetzfeldt, Newark, CA (US); Krzysztof Palacz, San Francisco, CA (US); Niklas Q. Nielsen, Gentofte (DK)

(72) Inventors: André Kruetzfeldt, Newark, CA (US); Krzysztof Palacz, San Francisco, CA (US); Niklas Q. Nielsen, Gentofte (DK)

(21) Appl. No.: 13/460,548

(22) Filed: Apr. 30, 2012

Related U.S. Application Data
(60) Provisional application No. 61/529,848, filed on Aug. 31, 2011.

(51) Int. Cl. G06F 9/44

(52) U.S. Cl. 717/130

(57) ABSTRACT

Systems and methods for dynamic collection of probes may employ a probe collector process that runs in conjunction with (or following) a memory garbage collection operation. In response to receiving data indicating that a probe is to be removed from an application and encountering the probe during execution of the application, the probe may be marked for removal. The probe collector process may subsequently remove the probe by replacing some or all of the probe code with NOP instructions. If the probe code for a probe marked for removal includes a call to a probe stub, the probe collector process may replace the call with a NOP instruction. In response to receiving data indicating that the removed probe should be reactivated, the NOP instruction(s) may be replaced with the previously removed probe code. Probe code for probes that are not marked for removal or that are reactivated may be executed.

### PRIORITY INFORMATION

This application claims benefit of priority of U.S. Provisional Application Ser. No. 61/529,848 entitled “Systems and Methods for Dynamic Re-Allocation of Collectable Code Pointers” filed Aug. 31, 2011, the content of which is incorporated by reference herein in its entirety.

### BACKGROUND

### Description of the Related Art

Providing reliable, secure and well performing software is a crucial task for any software vendor. Unfortunately, it is too often the case that these goals are not met. For example, much time and many resources can be spent discovering, locating, and correcting software failures. Without well-designed and clever tools, this can be an arduous task.

Many useful tools for debugging and profiling code exist, but these are typically extremely dependent on the underlying operating system and architecture. For this and other reasons, instrumenting application code that is meant to be executed on embedded devices (such as handheld computers or tablet computing devices) can be a very tedious task.

Current probing mechanisms, including profiling, debugging, and/or aspect oriented weaving mechanisms are typically hard-compiled into the application code or into the infrastructure or runtime environment code. In some cases these mechanisms can be collectively (and completely) switched on and off, as needed.

### SUMMARY

Systems and methods for implementing and using programmable and collectable probes are disclosed. In some embodiments, one or more of these probes may be inserted into an application at respective call sites. Subsequently, one or more of these probes may be selected for activation or removal for a given execution pass of the application into which they have been inserted. For example, in some embodiments, data received at run time may include a unique identifier of each one or more probes that are to be active during the execution pass and/or a unique identifier of one or more probes that are to be removed. In some embodiments, the received data may indicate that only a subset of the probes (i.e. fewer than all of the probes) that have been inserted into the application should be active (i.e. enabled) or removed (i.e. disabled) during the execution pass. In various embodiments, receiving the instrumentation selection data at run time may include accessing a file in which the data has been recorded, obtaining the data from a memory in which it has been stored, and/or receiving the data from a command line interface or a graphical user interface.

During run time, probe code for any probe that has been designated as an active probe may be executed and may perform (or call a probe handler to perform) one or more data collection tasks, profiling a method of the application, or, more generally, any functionality selectable for execution at run time. During run time, probes that have been designated for removal may be marked as such, and some or all of the associated probe code (e.g., code for performing the selectable functionality associated with the probe) may not be executed. In other words, in response to receiving data indicating that a probe is to be removed from an instrumented application and encountering the probe during execution of the application, the probe may be marked for removal without performing the tasks associated with the probe.

In some embodiments, the removal of probes may be performed by a probe collector process, which may be executed by a thread that is distinct from any threads executing the instrumented application. Prior to removing any probes, the probe collector process may access the instrumented application to determine which, if any, of the probes have been marked for removal. In some embodiments, a probe collector process may remove any probe(s) marked for removal by replacing some or all of the associated probe code with no operation (NOP) instructions. For example, if the probe code for a probe marked for removal includes a call to a probe stub, the probe collector process may replace the call with a NOP instruction. In some embodiments, the probe collector process may also replace one or more other instructions with NOP instructions (e.g., instructions for passing arguments to the probe stub and/or instructions for cleaning up after returning from a call to the probe stub). In some embodiments, the probe collector process may run in conjunction with (or following) a memory garbage collection operation (e.g., while execution of the instrumented application is in a safe state). In other embodiments, the decision about which, if any, probes should be inserted in or omitted from the compiled code may be performed by a just-in-time (JIT) compiler at run time.

In some embodiments, in response to receiving data indicating that a removed probe should be reactivated, any NOP instructions that were inserted by the probe collector (e.g., overwriting some or all of the associated probe code) may be replaced with the previously removed probe code. Probe code for any probes that have been reactivated may be executed when execution of the application continues and/or during a subsequent execution pass.

### BRIEF DESCRIPTION OF THE DRAWINGS

FIG. 1 is a flow diagram illustrating one embodiment of a method for using programmable and collectable probes in applications executing in various runtime environments.

FIG. 2 is a flow diagram illustrating one embodiment of a method for implementing programmable and collectable probes in applications executing in various runtime environments.

FIG. 3 is a flow diagram illustrating one embodiment of a method for removing probes, according to one embodiment.

FIGS. 4A-4D are block diagrams illustrating the use of programmable and collectable probes in an application, according to one embodiment.

FIGS. 5A-5B and 6A-6B illustrate the removal of a programmable, collectable probe, according to different embodiments.

FIG. 7 illustrates the execution flow of an application that has been instrumented with programmable and collectable probes, according to one embodiment.

FIG. 8 illustrates the use of probes in an application that includes JIT methods, according to one embodiment.

FIG. 9 illustrates performance differences between instrumented and un-instrumented methods of an application, according to one embodiment.

FIG. 10 illustrates an example computer system that is configured to implement and use one or more programmable and collectable probes in applications executing in various runtime environments, according to some embodiments.

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The systems and methods described herein may provide an infrastructure to enable developers to produce high quality instrumentation. These systems and methods may include probing techniques that result in minimal overhead, as has been demonstrated by their application to concurrent versions of Adobe® ActionScript™ Virtual Machine (AVM), such as the Tamarin AVM. Unlike current probing mechanisms, which are generally not removed or re-coded in a performance optimized manner, the mechanisms described herein may allow for optimized code weaving with a minimal performance loss. For example, current measurements of the impact of the instrumentation techniques described herein have indicated that they may result in a performance degradation of less than 0.5%, in some embodiments.

The systems described herein, which may include programmable and collectable probes (which may sometimes be referred to herein as “AVM probes”) may provide a self-contained, operating-system-independent probe infrastructure. In some embodiments of these systems, the overhead incurred due to the presence of disabled probes may be minimal. In fact, in some embodiments, this overhead may sometimes be avoided altogether. The probes themselves may be named according to a defined scheme, which may allow one or multiple probes to be enabled for a given execution pass. For example, by applying a defined naming scheme in which each probe can be uniquely identified, it may be possible to enable or disable less than all of a collection of multiple probes that have been inserted into an application for a given execution pass. In some embodiments, the names of the probes inserted into an application may be unique down to the object level. The probes may be convenient to use, and may include variable length parameters and/or probe prologue code, in some embodiments.

In some embodiments, a system that employs AVM probes may include new mechanisms that implement dynamic, collected, and thread-safe call site removal, in which the system may remove inactive probes from the application code. In such embodiments, the removed probes, when encountered, may incur near zero overhead. In some embodiments, these systems may include a probe name space. The name space may provide a mechanism to indicate which, if any, probes are to be enabled during a particular execution pass, and/or mechanisms for workers to enable them. The systems described herein may be designed with performance in mind, and may be extended to express other instrumentation domains, as well.

The systems described herein may provide a new way to instrument, profile, and debug software by offering many possibilities for dynamic run-time code weaving. In some embodiments, these systems may enable high quality instrumentation and debugging facilities to be resident in applications without the need for separate debug or profiler builds. In some embodiments, these systems may be configured to remove probes from instrumented applications according to a desired behavior that is specified at run time. As previously noted, these mechanisms may result in very low overhead (e.g., on the order of 1% or lower) when not probing code (i.e. when the inserted probes are disabled at run time).

Managed runtime models often allow two or more main workflows (e.g., one interpreted and one compiled at run time), and may depend on the one or more intermediate representations to generate target engine code sets. Modern development practices may allow multiple aspects of a given problem to be solved in parallel using introspection and/or code weaving. Using current techniques, once the target code has been instrumented, only a reweaving can reverse the code changes in all of the workflows. The mechanisms described here may address and resolve these issues by dynamically recoding and collecting code intersections.

For example, it has been discovered that the dynamic insertion of code interweaving points (e.g., the injection of observable probes in various components of AVM) may in some embodiments be “collected” in a manner similar to the way in which memory is reclaimed through memory garbage collection for virtual machine objects. These interweaving sections may be resident in executable code pages, in contrast to managed objects (which are resident on the heap/stack), and the collection of these interweaving sections may in some embodiments be performed on a per-page basis.

In some embodiments, interweavable code segments (sometimes referred to herein simply as “probes”) may be replaced by no operation (NOP) instructions when not in use, and may be managed via a special collector type process (sometimes referred to herein as a “probe collector”) that is running as a separate process, distinct from the memory garbage collector found in managed environments. In some such embodiments, interweavable insertion points (sometimes referred to herein as “probe call sites”) may be listed in a separate hash table that is under control of the probe collector and that follows special security policies to guarantee code weaving hardening.

Providing a probe infrastructure to enable developers to obtain high quality information about the internals of a complex system (e.g., a virtual machine such as Tamarin AVM) may in some embodiments increase transparency and ease development of both the virtual machine and any scripts running on the virtual machine. The systems described herein may in some embodiments achieve this by providing a convenient set of primitives usable to insert probes, and to collect and/or display data.

For example, debugging may be difficult in the AVM through a cross-platform browser application (such as the Flash Player application from Adobe Systems), and may become increasingly complex when concurrency is added to the virtual machine. In some embodiments, breakpoints may be implemented using AVM probes, as described herein. The techniques described herein may in some embodiments be applied to debugging, and may allow breakpoints to be inserted at run time. For example, a hook to the debugger may be inserted as a handler for the special type of programmable, collectable probes described herein, allowing the debugger to act upon breakpoints only when one or more of these probes is enabled at run time.

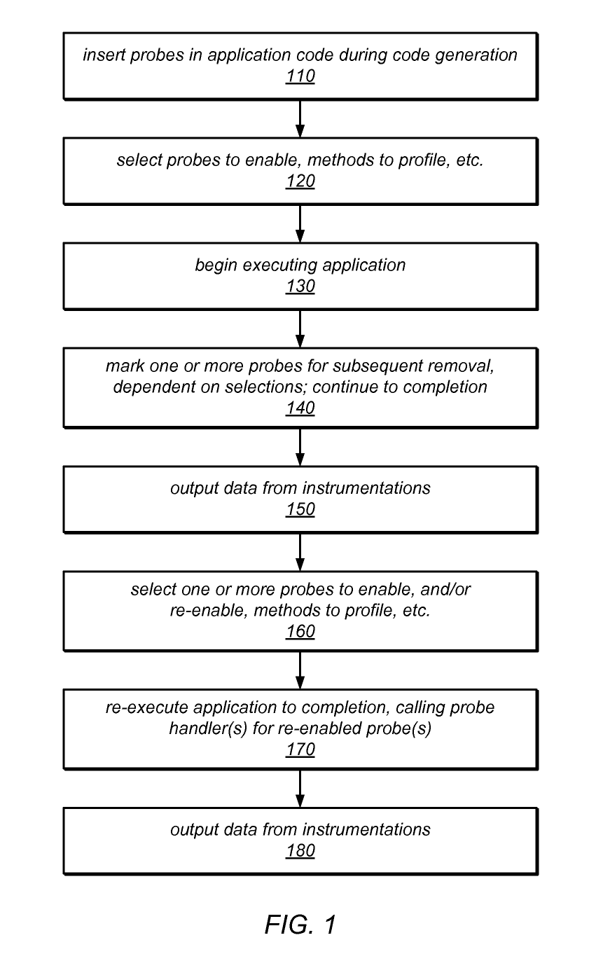

One embodiment of a method for using programmable and collectable probes in applications executing in various runtime environments is illustrated by the flow diagram in FIG. 1. As illustrated in this example, the method may include a developer (e.g., a programmer) inserting one or more probes in application code during code generation, as in 110. The probes may be inserted at any level in the code hierarchy, including at the object level or any higher level, in different embodiments.

As illustrated in this example, the method may also include the developer (or another user) selecting the instrumentations that are to be active during a particular execution of the application. In other words, the developer may select one or more of the inserted probes to enable, methods to profile, etc., as in 120. In various embodiments, performing instrumentation selection may include editing a configuration file or data structure that indicates which, if any, probes are to be enabled, entering one or more probe selections through a command line interface or a graphical user interface of the infrastructure or runtime environment (e.g., using switches, queries, or other command formats), editing a header file for the application, and/or selecting active probes through any of a variety of other input selection means. In various embodiments, each of the probes may be identified for activation and/or removal by a duple that includes a domain (or namespace) name and a probe name, and that uniquely identifies them from among the probes that have been inserted in the code. Note that in some embodiments, a run time selection must be made for each of the probes that have been inserted into the application code to designate the probe as active (enabled) or inactive (disabled). In other embodiments, if a subset of the inserted probes is selected for activation at run time, the remaining inserted probes may be implicitly designated as inactive probes for the upcoming execution pass. Conversely, if a subset of the inserted probes is selected for deactivation at run time, the remaining inserted probes may be implicitly designated as active probes for the upcoming execution pass.

As illustrated in this example, the method may include the infrastructure or runtime environment beginning execution of the instrumented application (as in 130), and (during execution) marking one or more of the probes for subsequent removal, dependent on the instrumentation selections that were made (as in 140). The execution of the application may then continue through completion. For example, in some embodiments an AVM infrastructure executing an application that has been instrumented with probes may call a respective probe stub for each inserted probe, and the probe stub for each probe may check the selection information to determine whether the probe is enabled for the current execution run of the application. The probe stub for each of the enabled probes may then call a respective probe handler (which may collect data from these enabled instrumentation points). The probe stub for each of the un-selected probes may call (or send a message to) a probe collector indicating that the probe should be marked (or scheduled) for subsequent removal. As illustrated at 150, in this example, any data collected from the enabled instrumentations (e.g., the active probes, profiled methods, etc.) may be output by the infrastructure as execution progresses or after execution is complete, in different embodiments.

As illustrated in this example, the method may include the developer selecting one or more probes to enable (or re-enable), methods to profile, etc. for a subsequent execution of the application or for execution of a subsequent portion of the application during the current execution run, as in 160. In such embodiments, the infrastructure may re-execute (or continue executing) the application to completion, calling probe handler(s) for any enabled and/or re-enabled probe(s), as in 170, and outputting data from the enabled instrumentations, as in 180. In some embodiments, instrumentation selections may be saved in a configuration file, in a data structure, in an application header, in a script, or in another suitable format for possible use in future execution passes. In some embodiments, saved instrumentation selections may be overwritten. In other embodiments, instrumentation selections may be explicitly specified for each execution pass.

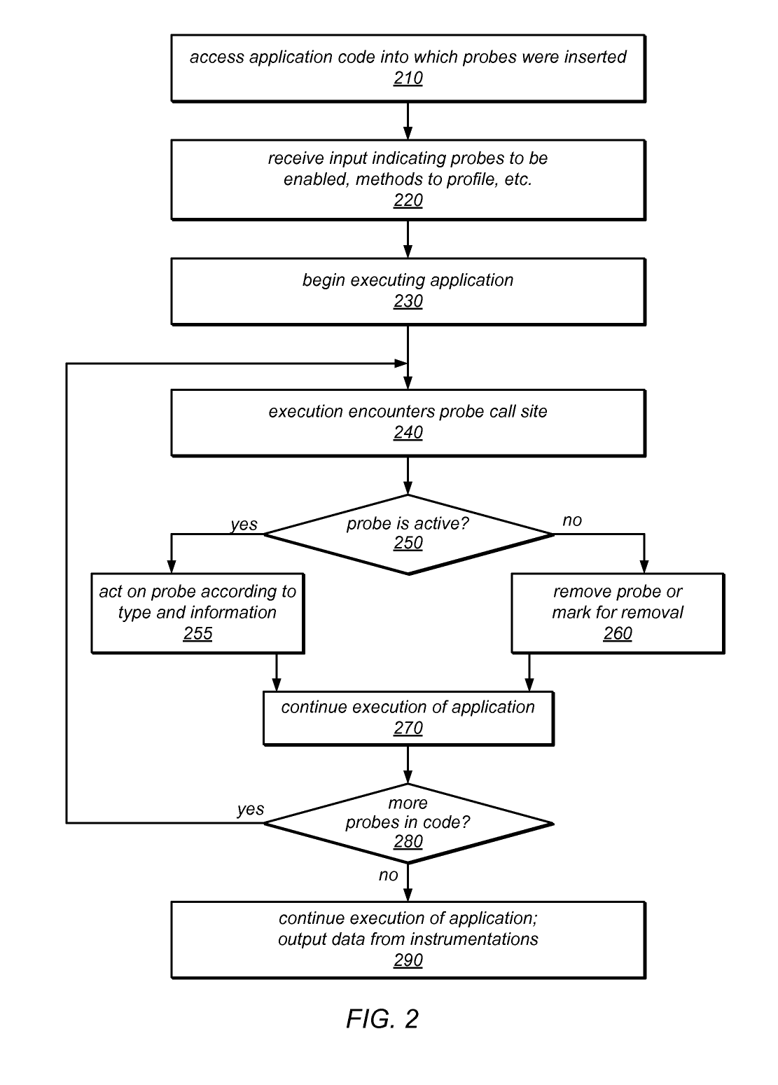

One embodiment of a method for implementing programmable and collectable probes in applications executing in various runtime environments is illustrated by the flow diagram in FIG. 2. As illustrated in this example, the method may include the infrastructure (or runtime environment) accessing application code into which probes have been inserted (as in 210), and receiving input (e.g., through a user interface or by accessing stored data) indicating which, if any, of the probes are to be enabled during upcoming execution of the application code, indicating any methods that are to be profiled during the execution, and/or indicating any other profiling mechanisms that are to be enabled during execution (as in 220). As noted above, performing this instrumentation selection may include editing a configuration file or data structure that indicates which, if any, probes are enabled, entering one or more probe selections through a command line interface or a graphical user interface of the infrastructure or runtime environment (e.g., using switches, queries, or other command formats), editing a header file for the application, and/or selecting active probes through any of a variety of other input selection means, in various embodiments.

As illustrated in this example, the method may include the infrastructure beginning execution of the instrumented application (as in 230). When and if a probe call site is encountered (as in 240), the method may include determining whether the probe is active, according to the instrumentation selections (as in 250). If so, the method may include acting on the probe according to its type and other information (as in 255). For example, if the probe is active, a corresponding probe handler may be called that invokes methods to collect data for a debugging or profiling exercise. As illustrated in this example, if the probe is not active, it may be removed or marked for subsequent removal (as in 260), before execution of the application continues (as in 270). As illustrated in FIG. 2, in some embodiments the operations illustrated at 240-270 may be repeated as any additional probe call sites are encountered during execution of the application code (shown as the feedback from 280 to 240). As illustrated in this example, the method may include outputting data from the enabled probes and/or other enabled instrumentations (as in 290). While FIG. 2 illustrates an embodiment in which all of the data collected from the active and/or enabled probes and other instrumentations is output once all of the data has been collected, in other embodiments, data that is collected by the active/enabled probes and/or other instrumentations may be output as soon as it is collected, or at any other point following its collection.

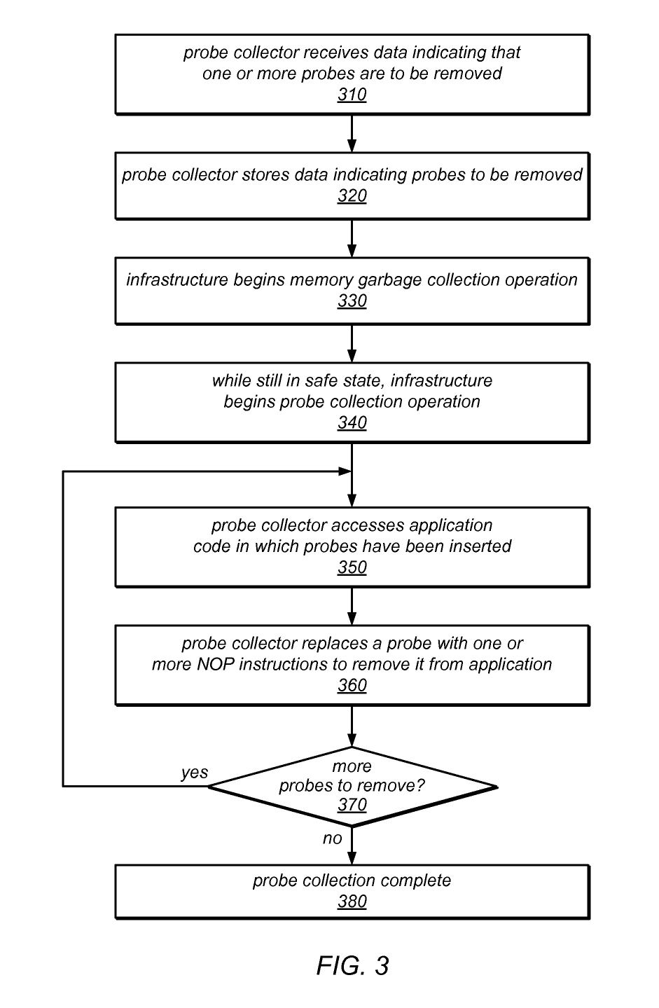

As previously noted, probes that have been marked or scheduled for removal based on a selection of active/enabled or inactive/disabled probes from among those that were inserted in application code may be subsequently removed by a probe collector. One embodiment of a method for removing probes from an application is illustrated by the flow diagram in FIG. 3. As illustrated in this example, the method may include a probe collector (which may be a thread distinct from any threads executing the application) receiving data (or accessing stored data) indicating that one or more probes are to be removed from the application code (as in 310). For example, the data may be received through or obtained from a command line interface, a switch, header information, a configuration file, or another mechanism or data structure, in different embodiments. The received data may indicate one probe that should be removed at a time or may indicate a group of probes that should (collectively) be removed, in different embodiments. As illustrated in this example, the method may include the probe collector storing data indicating the probe or probes that are to be removed (as in 320). For example, the probe collector may store data indicating the probe or probes that are to be removed in a configuration file or in any suitable data structure (unless this data has already been stored by the thread that reported the indication to remove the probe or probes).

As illustrated in FIG. 3, the method may include the infrastructure (or runtime environment) beginning a memory garbage collection operation (as in 330), and, while still in a safe state (e.g., at or near the end of the memory garbage collection operation), beginning a probe collection operation (as in 340). In this example, in response to initiation of the probe collection operation by the infrastructure or runtime environment, a probe collector may access the application code into which the probes were inserted (as in 350), and may replace a probe that has been marked or scheduled for removal with one or more NOP instructions to remove it from application (as in 360). As illustrated in FIG. 3, the operations illustrated at 350 and 360 may be repeated to remove additional probes that have been marked or scheduled for removal from the application (shown as the feedback from 370 to 350), until the probe collection operation is complete (as in 380).

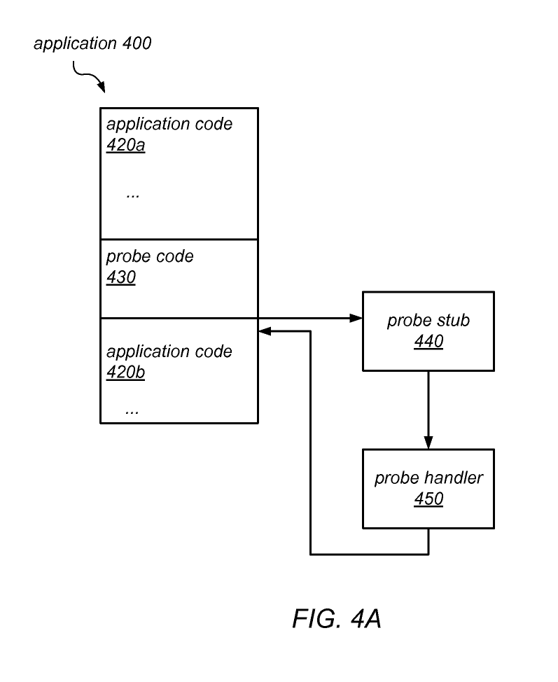

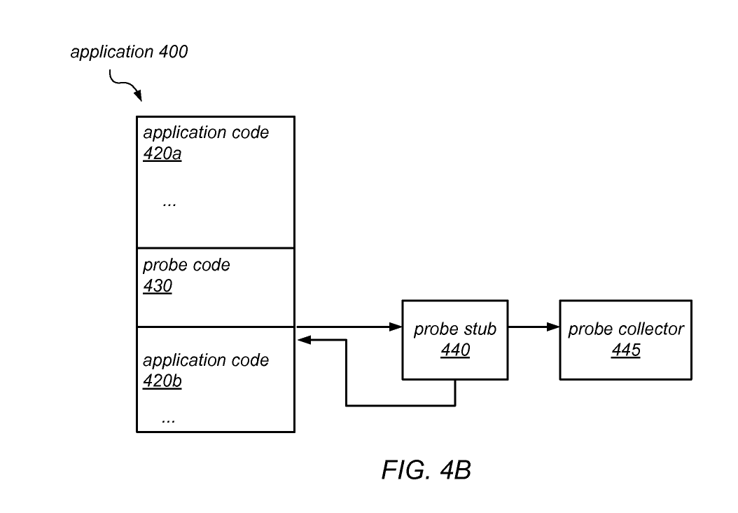

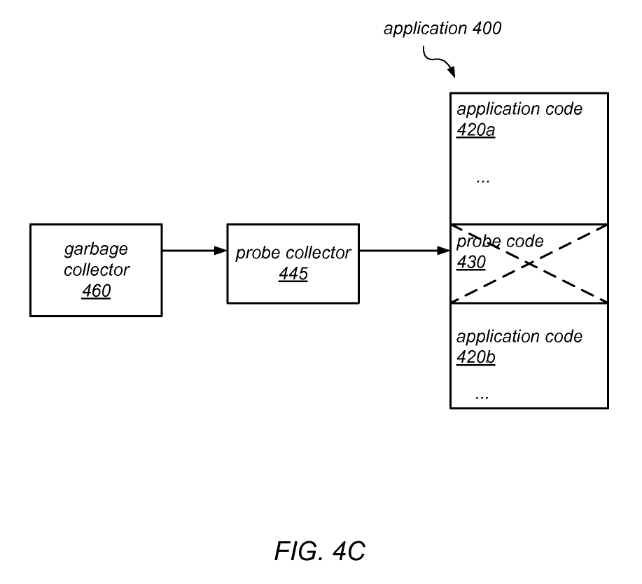

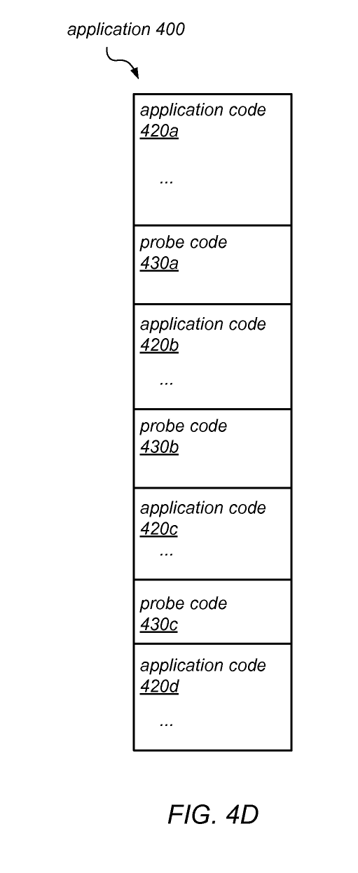

The use of programmable and collectable probes in an application may be further illustrated by the block diagrams in FIGS. 4A-4D, according to one embodiment. In these examples, it is assumed that the code for application 400 includes one or more probes 430, each of which may include code for passing arguments to a respective probe stub 440 and/or for calling the respective probe stub. As previously noted, a probe stub may include code executable to determine whether the corresponding probe is enabled for the current execution pass of application 400. As illustrated in FIG. 4A, during execution of application 400, a portion of the application code (shown as application code 420a) may be executed, and a particular probe call site (shown as probe code 430) may be encountered, and the corresponding probe stub (shown as probe stub 440) may be called and/or when arguments are passed to the probe stub. If the probe corresponding to this probe call site (i.e. the probe corresponding to probe code 430) is enabled, when the corresponding probe stub 440 is called (and/or when arguments are passed to it), the probe stub 440 may call a respective probe handler 450. In some embodiments, the probe handler 450 may collect data for a debugging or profiling exercise, or may perform other functions (including, e.g., outputting and/or displaying the arguments passed to the probe stub and/or probe handler, or outputting and/or displaying any data collected by the probe handler), before the execution of application 400 continues (e.g., with the execution of the portion of application 400 shown as application code 420b).

As illustrated in FIG. 4B, during execution of application 400, a portion of the application code (shown as application code 420a) may be executed, and a particular probe call site (shown as probe code 430) may be encountered, and the corresponding probe stub (shown as probe stub 440) may be called and/or when arguments are passed to the probe stub. If the probe corresponding to this probe call site (i.e. the probe corresponding to probe code 430) is not enabled, when the corresponding probe stub 440 is called (and/or when arguments are passed to it), instead of the probe stub 440 calling a respective probe handler for the probe, the probe stub 440 may call a respective probe collector 445. In some embodiments, the probe collector may log or otherwise store data indicating that the particular probe 430 is to be removed, may remove the particular probe 430, and/or may schedule the particular probe for subsequent removal, in various embodiments, before the execution of application 400 continues (e.g., with the execution of the portion of application 400 shown as application code 420b).

As illustrated in FIG. 4C, in response to a particular probe 430 being scheduled for removal, a probe collector 445 (e.g., one that is invoked by a garbage collector 460, or in response to initiation, completion, or performance of a garbage collection operation) may remove the particular probe 430 by overwriting the code at its call site with one or more NOP instructions. For example, a probe collector may be invoked during a period in which it is safe to modify the executable code for application 400 (such as when application threads and/or other potentially interfering threads have been stopped or temporarily suspended in order to perform a memory garbage collection operation). As illustrated in this example, removing (or overwriting) probe code 430

FIG. 4D illustrates an application 400 into which multiple probes (430a-430c) have been inserted at respective probe call sites in between other portions of the application code (shown as application code 420a-420d). In this example, each of the probes may include code for passing arguments to a respective probe stub 440 (not shown) and/or calling the probe stub, as described above.

In some embodiments, removing a probe call site may require knowledge of two parameters of the probe call site: its location and its size. For example, when a method is called, the returning address may be pushed onto the stack. The return instruction may pop this address and jump to the location specified as the returning address. In some embodiments, this mechanism may be exploited in order to fetch a probe address, or in order to fetch a location known to be close to a probe location.

Determining the size of the call site of a code point can be difficult. For example, attempting to determine the call site instructions based on assumptions of the application binary interface (ABI) of the architecture may not be suitable or yield the desired result. In general, the method by which parameters are provided to an instrumented method may be dependent on (and may the responsibility of) the compiler. In various embodiments, removing a call site may be performed in variety of ways, including (but not limited to) the two described in detail below.

In some embodiments, removing a probe may involve removing the single call instruction that calls the corresponding probe stub. Using this method, the base pointer may “belong” to the caller. In some embodiments, removing the single call instruction may be a relatively safe way to void the call site, since this single call instruction can, typically, be easily identified. In embodiments that employ this method, if the callee were to consume any parameters from the stack, the stack may be adjusted after the call by the caller. Using this method, instructions for parameter saving and pushing may be retained, even in situations in which the probes themselves are deactivated. However, when a probe is deactivated, the actual call and mechanics for looking up the probe (e.g., in the name space) may be removed.

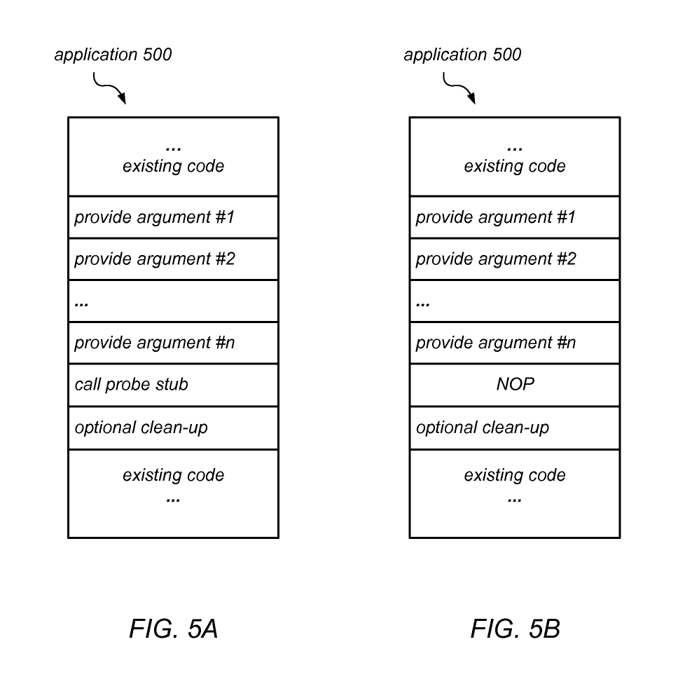

FIG. 5A illustrates application code for an application 500 that has been instrumented as described herein and that includes an active probe call site, according to one embodiment. Specifically, FIG. 5A illustrates an application code segment into which code for passing n arguments to a probe stub, calling the probe stub, and then cleaning up after the returning from the probe stub has been inserted between two previously existing portions of the application. FIG. 5B illustrates the same code segment following the removal of the probe in a manner similar to that described above. In this example, the call to the probe stub has been replaced by a NOP instruction, thus removing (e.g., voiding or disabling) the probe call site, but the code for passing n arguments to the probe stub, and the code for cleaning up after returning from the probe stub have not been removed.

In other embodiments, removing a probe may involve removing the entire probe call site, e.g., by recognizing code signatures surrounding the probe call site. In embodiments in which this method is employed, NOP instructions (NOPs) may replace code for parameter saving and pushing and/or clean up in addition to the call and mechanics for looking up the probe. Note that NOPs can be implemented in different ways on different architectures. In some embodiments, the variety, the order, and or the number of the instructions inserted or replaced may be used to create a signature. This signature may be skipped by the processor during execution of the instrumented application, but may leave a mark for a probe removal mechanism to record the precise location and size of a probe call site (which in some embodiments may facilitate the removal of the probe and/or a subsequent reinstatement of the removed probe).

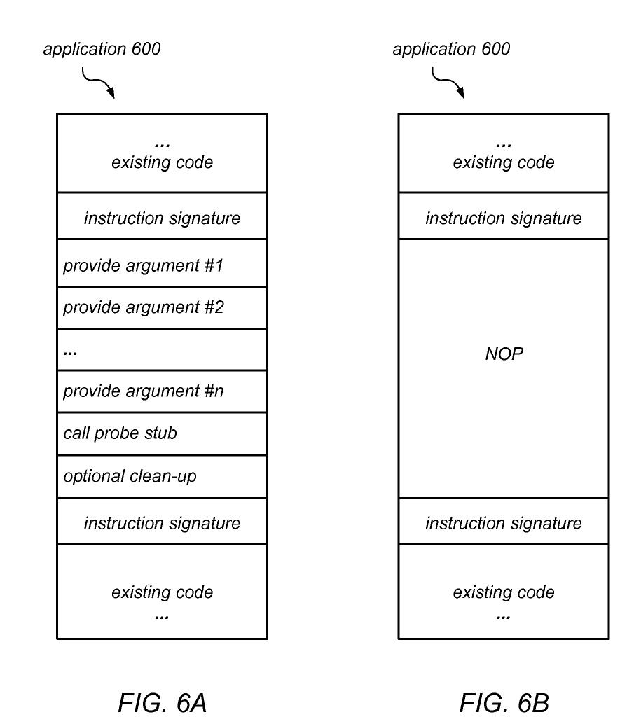

FIG. 6A illustrates application code for an application 600 that has been instrumented as described herein and that includes an active call site, according to one embodiment. Specifically, FIG. 6A illustrates an application code segment into which probe code for passing n arguments to a probe stub, calling the probe stub, and then cleaning up after returning from the probe stub has been inserted between two previously existing portions of the application. In this example, the probe code is bracketed by instruction signatures, as described herein. FIG. 6B illustrates the same code segment following the removal of the probe in a manner similar to that described above. In this example, all of the probe code (including the code for passing n arguments to a probe stub, calling the probe stub, and then cleaning up after the returning from the probe stub) has been replaced by one or more NOP instructions, thus removing (e.g., voiding or disabling) the probe call site, but the instruction signatures remain intact. Inserting the instruction signatures (and then leaving them intact) may in some embodiments facilitate both the removal of the probe and/or the reinstatement of the probe at another time.

In some embodiments, if any instruction sequences within the probe code are of the same length as the call site signatures, this may leave the call site in an undesirable state. For example, during probe removal, instructions could be cut in half, which may lead to an unpredictable behavior. In such embodiments, making the signatures longer than a single instruction and/or ensuring that the signatures are of a complexity that a compiler would not be likely to insert may mitigate this risk. In some embodiments, if the compiler inserts instructions to compensate for time delays for slow instructions, this may put pre-existing (i.e. original) instructions into the call site. In this case, removing the call site may leave the existing code in an undesirable state. In some embodiments, this risk may be reduced by giving hints to the compiler. For example, dedicated compiler mechanisms (e.g., #pragma directives in C/C++, or other types of special purpose functions or special language/syntax constructs) may provide hints usable to prevent unintended reordering within blocks of code. In some embodiments, making the call site conditional may prevent surrounding instructions from being mixed with probe call site instructions. However, in some cases, e.g., if the specified conditional is dependent on an expression that is resolvable at compile-time, it may be optimized out by the compiler. In some embodiments, unintended reordering and/or optimization issues may be avoided when the probe call sites are generated by the probe infrastructure itself. For example, instructing the compiler to construct a control block of its own for a probe call site (e.g., by placing call sites within conditional blocks) may lead to safer call site removals. Note that, in general, the techniques described herein may be implemented in systems that support a wide variety of ABI calling conventions and formats (including those that support a variable number of arguments).

In some embodiments, the programmable, collectable probes described herein may be used as follows:

1. A user initiates execution of the virtual machine with a specified instrumentation selection.

2. The virtual machine runs and collects data from the enabled instrumentation points (probes).

3. The collected data is output while the virtual machine is running or at end of its execution.

In some embodiments, developers may insert probes similar to those found in the following pseudo code example:

...
AVMPROBE(“NanoJit”, “method-compile-begin”, methodName);
startTime = timestamp( );
// Instantiate method compilation
// ...
memoryConsumption = ...
elapsed = timestamp( ) − startTime;
AVMPROBE(“NanoJit”, “method-compile-end”, methodName, elapsed,
memoryConsumption);
...

In some embodiments, debugging tools may use the programmable, collectable probes described herein to instrument existing software in great detail, and to provide and/or display overviews of the data collected (e.g., sequence diagrams of concurrent data exchange between workers).

In some embodiments, the instrumentations described herein may be added by virtual machine developers when adding new functionality or changing existing functionality. For example, a developer may insert probes into general virtual machine code and may use them to provide a type of code review.

In some embodiments, an AVM probe namespace may include one or more of the following classes:

| Class | Description |
|---|---|
| AVMProbes | An entry class to the infrastructure. |
| AVMProbeNamespace | A class to provide a namespace specific look-up |
| | mechanism. Can be used for any kind of |
| | structured instrumentation lookup. |
| AVMProbeCache | A simple caching class for probes that have been |
| | looked up. |
| AVMInstaller | A class to provide removal and/or reinsertion of |
| | probe call sites. If removal cannot be guaranteed |
| | to be done safely, call sites may be left |
| | untouched. |
| AVMInstruments | A utility class to provide system instrumentation, |
| | e.g., system timers, current process |
| | identifiers, etc. |
| AVMHandler | If a probe is enabled, its handler may be called |
| | through this class. Lookups can be done, such |
| | that probes will be handled in different ways. |

In some embodiments, changes may be made to existing classes to support the programmable, collectable probes described herein. For example, a new kind of read-write lock may be added to a VMThread class to provide fast probe look-ups in concurrent environments. In another example, probe collection and removal may be piggybacked on the sweep routine of a memory garbage collector. For example, in some embodiments a call to a probe collector (one that performs probe collection/removal) may be added as a final step in the sweep routine to ensure that the probe collector runs at a safe time (i.e. while the instrumented application is in a safe state).

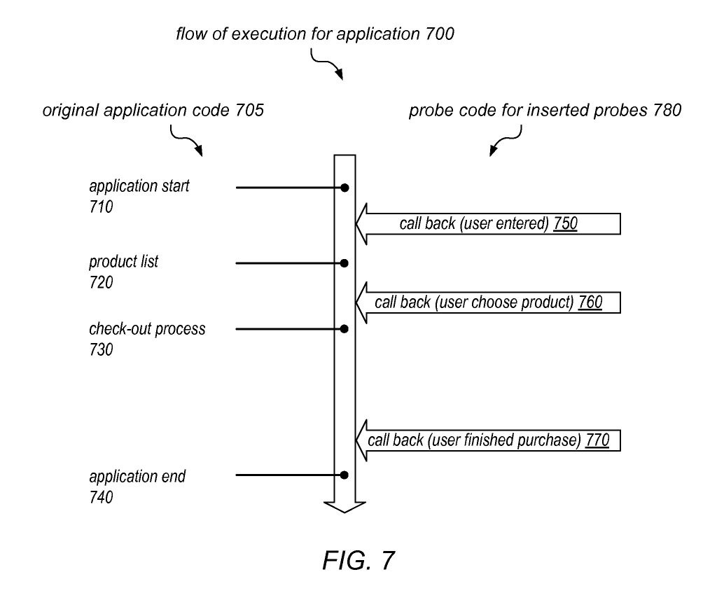

The techniques described herein may be further illustrated by the execution flow illustrated in FIG. 7, according to one embodiment. In the example illustrated in FIG. 7, the original application code 705 for an application 700 has been instrumented with programmable and collectable probes 780, according to one embodiment. In this example, the application may be an e-commerce type application, in which a user purchases one or more products. After execution of application 700 begins (at 710), probe code for an enabled probe 750 may be called that facilitates a user initiating a transaction and/or entering data indicating a desire to make a purchase. In response to the input received during the execution of probe 750, the application may display a product list (at 720). Subsequently, probe code for another enabled probe (760) may be called that facilitates the selection of a product by the user. When the application reaches a check-out process (shown at 730), probe code for another probe (if enabled) may facilitate completion of the user's purchase (as in 770), before execution of application 700 ends (at 740). In this example, one or more of the probes 750, 760 and/or 770 may be disabled if the user is not authenticated, if the user does not have permissions to access the probe methods, or for other reasons.

Fast dynamic probes, such as those described herein, may provide a variety of functions for debugging, profiling, and dynamically recoding applications, in different embodiments. For example, in some embodiments, handlers may be written in a constrained language, interpreted by the resident compiler in a virtual machine (such as AVM), and hooked into AVM probe handlers. In some such embodiments, for a given probe call site, one of multiple probe handlers may be selected for execution at run time, depending on the desired behavior, or the probe may be removed. In other words, instead of having only two choices for the run time behavior of a probe call site (i.e. enabled or disabled), in some embodiments, there may be multiple options for the code to be executed when an active probe is encountered, and the particular option to be enabled may be specified at run time (e.g., using multiple configuration parameters or command line switches). In some embodiments, prior to probe call site removal, probe call sites may be saved for later reinsertion. This may enable a long-lived process to be instrumented without starting or stopping it. In some embodiments, rather than a developer inserting probes manually into program code, a just-in-time (JIT) compiler (e.g., the JIT compiler in Tamarin AVM) may make use of both the probe name space and probe collector to provide function boundary tracing.

In some embodiments, the programmable, collectable probes described herein may be used to provide JIT method profiling. Profiling code is usually very platform dependent, with different tools and techniques being offered for different operating systems and/or architectures. For example, NanoJIT in Tamarin AVM compiles code on-the-fly and the generated methods can be hard to instrument. In some embodiments, the programmable, collectable probes described herein may be used for generating profiled code. For example, causing NanoJIT to produce probe code before and after a method may make it possible to provide profile data about jitted code (the code of a JIT method). This technique may provide developers with useful information about their code, whether or not optimizations such as JIT compiling are used.

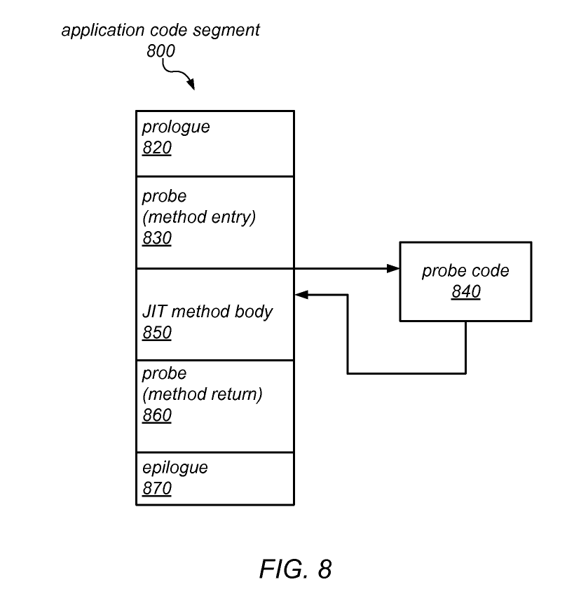

The use of probes in an application that includes JIT methods may be further illustrated by the block diagram in FIG. 8, according to one embodiment. In this example, an application code segment 800 includes a prologue (shown as 820), a probe corresponding to a method entry point (shown as 830), the method body (shown as 850), a probe corresponding to a method return point (shown as 860), and an epilogue (shown as 870). In this example, if the probes (830 and 860) are enabled, the corresponding probe code 840 may call the appropriate probe handler to collect profile data during execution of the JIT method body (850). Otherwise, the probes (both 830 and 860) may be scheduled for removal. For example, an AVM probe infrastructure may determine whether or not to profile this particular JIT method (850). If so, a probe handler called by probe code 840 may record data upon the method entry and the method return. If not, probe code 840 may remove the entry and return probes (830 and 860), as described above. In this example, the entry and return probes (830 and 860) may define the boundaries of the JIT method (850). Such entry and return probes may in some embodiments be used for function boundary tracing. In one embodiment, the entry and return probes may be included in the JIT method namespace, as follows:
for a JIT function foo( );
*::JIT-method::foo-entry
*::JIT-method::foo-return

As described herein, in some embodiments the JIT compiler may decide (e.g., based on the AVM probe infrastructure or a namespace subsystem thereof) whether or not to insert various probes into the compiled code at run time. In some such embodiments, the JIT compiler may insert one or more NOP instructions as place-holders for any disabled probes and may save the probe code emitted by the compiler for potential reinsertion at a later time. In such embodiments, there may be no need to schedule the inactive probes for removal from the jitted code initially. However, any subsequent removal and/or deactivation of probes may be carried out as described herein.

In some embodiments, the programmable, collectable probes described herein may be used for more than code instrumentation and debugging. For example, in some embodiments, they may be used as a general mechanism for offering dynamic run time behavior with low overhead. For example, a program may be made to behave differently based on a user agreement dependent on an applicable privacy agreement. In this example, probes may be used to collect data and push it forward to, e.g., affiliate software, if the user agrees to allow this. If not, those probes may be removed.

In another example, the programmable, collectable probes described herein may be used to enable or disable features of an application based on a user's license level. In yet another example, a developer may use the programmable, collectable probes described herein to try out new features, e.g., initially enabling them only for beta testers, and later (once they are sufficiently tested) enabling them for all users. Similarly, in some embodiments the programmable, collectable probes described herein be used for patching application code (e.g., by causing probe code at a call site to call a new patch and/or by replacing old code in a probe handler with new code. In general, the programmable, collectable probes described herein may be used to facilitate any type of run time code weaving in which it is desirable to make the decision about what probes and/or functions to enable or disable at run time.

As previously noted, the probe infrastructure described herein may in various embodiments have minimal influence on execution performance (specifically, on “normal” execution, with most or all probes disabled). In one example, with probes inserted in coerce methods in the virtual machine that are called 1,000,000 to 2,000,000+ times, the performance impact on a particular performance test suite was shown to be minimal. In other words, using the instrumentation and probe removal techniques described herein, the presence of deactivated probes in application code may have minimal influence on normal execution speed.

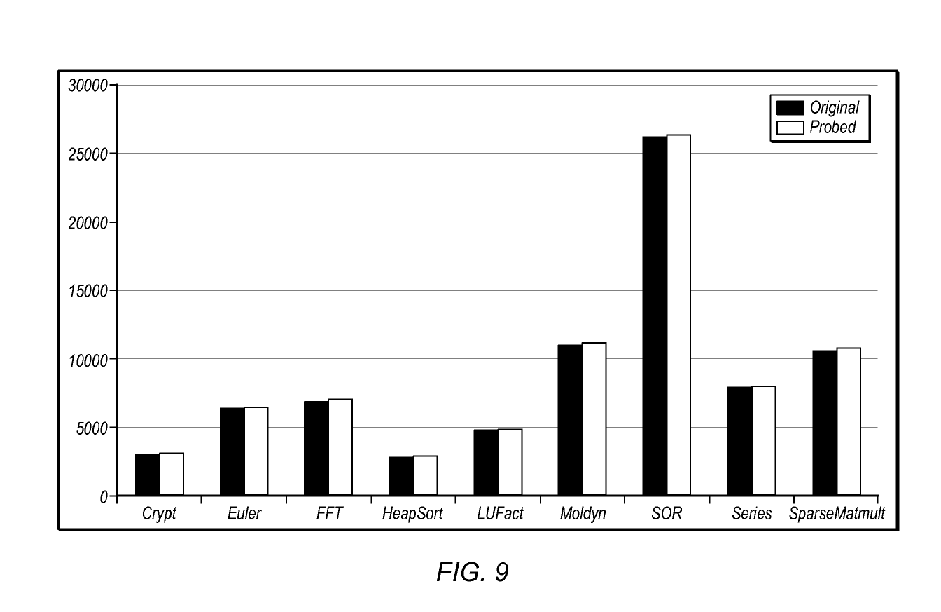

FIG. 9 illustrates performance differences between instrumented and un-instrumented methods of an application, according to one embodiment. Specifically, this example illustrates timing data for execution of an original application (in this case, an original version of Tamarin AVM), and for a probed version of the same application in which the probes are deactivated. In this example, the probed version contains probes in tight loops (e.g., in the interpreter), which are encountered more than 80,000 times. In FIG. 9, for each pair of bars, the solid black bar on the left represents the performance of the original (non-probed) version of a particular method, and the white bar on the right represents the performance of the probed version of the same method when the probes are deactivated. As illustrated in FIG. 9, the performance differences are minimal.

Note that in some embodiments, a Dtrace like resident compiler may be provided that comprises a collection of probe handlers that collectively adhere closely to the standards established for Dtrace, but that are compiled by AVM's own JIT compiler into native code.

In various embodiments, the programmable, collectable probes described herein may enable what would otherwise be platform dependent instrumentation to be implemented as a self-contained, platform-independent probe infrastructure (e.g., self-contained within an application). This infrastructure may be used to provide transparent high-quality instrumentation with well-written probes, and may also provide a foundation for profiling of JIT methods and supporting debugger breakpoints. The infrastructure may in some embodiments be useable for generic dynamic run time code weaving.

### Example Implementations

Some embodiments may include a means for inserting probes into application code. For example, a probe insertion module may receive input through a user interface specifying code for one or more probes, and may insert that probe code into the application code during generation or compilation of executable code for the application, as described herein. The probe insertion module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform receiving input through a user interface specifying code for one or more probes, and insert that probe code into the application code during generation or compilation of executable code for the application, as described herein. Other embodiments of the probe insertion module may be at least partially implemented by hardware circuitry and/or firmware stored, for example, in a non-volatile memory.

Some embodiments may include a means for enabling and/or disabling various probes in application code at run time. For example, a probe selection module may receive input indicating which probes are to be activated and/or removed at run time, and may mark the probes for active execution or removal, as described herein. The probe selection module may in some embodiments be implemented by a non-transitory, computer-readable storage medium and one or more processors (e.g., CPUs and/or GPUs) of a computing apparatus. The non-transitory, computer-readable storage medium may store program instructions executable by the one or more processors to cause the computing apparatus to perform receiving input indicating which probes are to be activated and/or removed at run time, and marking the probes for active execution or removal, as described herein. Other embodiments of the probe selection module may be at least partially implemented by hardware circuitry and/or firmware stored, for example, in a non-volatile memory.

Some embodiments may include a means for removing probes from an application at run time based on selections made for the execution of the application. For example, a probe collector may receive an indication that a particular probe should be removed, and may remove the probe by replacing code at the call site for the probe with one or more NOPs, as described herein. The probe collector may in some embodiments be implemented by a non-transitory, computer-readable storage medium and one or more processors (e.g., CPUs and/or GPUs) of a computing apparatus. The non-transitory, computer-readable storage medium may store program instructions executable by the one or more processors to cause the computing apparatus to perform receiving an indication that a particular probe should be removed, and removing the probe by replacing code at the call site for the probe with one or more NOPs, as described herein. Other embodiments of the probe collector may be at least partially implemented by hardware circuitry and/or firmware stored, for example, in a non-volatile memory.

Some embodiments may include a means for receiving input specifying probe code to be inserted into an application and/or for receiving input specifying which probes in a collection of inserted probes are to be activated and/or removed at run time. For example, a user interface module may receive input representing code for one or more probes to be inserted into an application, and/or may receive input identifying one or more probes that are to be activated and/or removed from the application at run time, as described herein. The user interface module may in some embodiments be implemented by a non-transitory, computer-readable storage medium and one or more processors (e.g., CPUs and/or GPUs) of a computing apparatus. The non-transitory, computer-readable storage medium may store program instructions executable by the one or more processors to cause the computing apparatus to perform receiving input representing code for one or more probes to be inserted into an application, and/or receiving input identifying one or more probes that are to be activated and/or removed from the application at run time, as described herein. Other embodiments of the user interface module may be at least partially implemented by hardware circuitry and/or firmware stored, for example, in a non-volatile memory.

### Example System

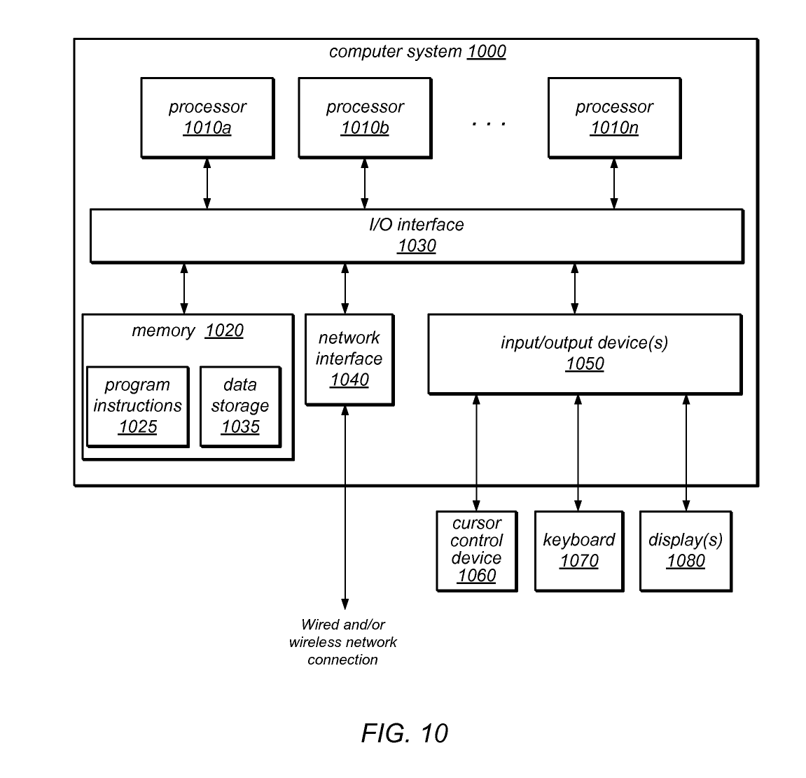

Embodiments of the modules described herein, such as a probe insertion module, a probe selection module, a probe collector, a compiler, a JIT compiler, a user interface module, and/or a runtime environment (e.g., AVM), and/or of various sub-modules thereof, may be executed on one or more computer systems, which may interact with various other devices. FIG. 10 illustrates an example computer system that is configured to implement and use one or more programmable and collectable probes in applications executing in various runtime environments, according to some embodiments. In different embodiments, computer system 1000 may be any of various types of devices, including, but not limited to, a personal computer system, desktop computer, laptop, notebook, tablet device, slate device, netbook computer, mainframe computer system, handheld computer, workstation, network computer, camera, set top box, mobile device, consumer device, video game console, handheld video game device, application server, storage device, peripheral device (such as a switch, modem, or router), or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In various embodiments, cursor control device 1060 may include one or more stylus devices, mouse devices, touchpads, and/or any other suitable cursor control devices. In various embodiments, display devices 1080 may include one or more tablet or slate devices and/or other types of devices that include a display capability and serve as input and/or output devices. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a probe insertion module, a probe selection module, a probe collector, a compiler, a JIT compiler, a user interface module, a runtime environment (e.g., AVM), and/or any other modules and/or data for implementing the techniques described herein are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include non-transitory, computer-readable storage media or memory media such as magnetic or optical media (e.g., disk or CD/DVD-ROM), volatile or non-volatile media such as RAM (e.g. SDRAM, DDR, RDRAM, SRAM, etc.), ROM, etc., coupled to computer system 1000 via I/O interface 1030. In some embodiments, program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, cursor control devices, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 10, memory 1020 may include program instructions 1025, configured to implement embodiments of a probe insertion module, a probe selection module, a probe collector, a compiler, a JIT compiler, a user interface module, and/or a runtime (e.g., AVM) as described herein, and data storage 1035, comprising various data accessible by program instructions 1025. In one embodiment, program instructions 1025 may include software elements of embodiments of a probe insertion module, a probe selection module, a probe collector, a compiler, a JIT compiler, a user interface module, and/or a runtime (e.g., AVM) as illustrated in the above figures. Data storage 1035 may include data that may be used by a probe insertion module, a probe selection module, a probe collector, a compiler, a JIT compiler, a user interface module, and/or a runtime (e.g., AVM), in various embodiments. For example, in some embodiments, data storage 1035 may store data that uniquely identifies each of a plurality of probes that have been (or are to be) inserted into an application, and/or data indicating the selection of one or more of such probes that have been or are to be activated and/or removed from an application at run time. In other embodiments, other or different software elements and/or data may be included in memory 1020.

Those skilled in the art will appreciate that computer system 1000 is merely illustrative and is not intended to limit the scope of a probe insertion module, a probe selection module, a probe collector, a compiler, a JIT compiler, a user interface module, and/or a runtime (e.g., AVM) as described herein. In particular, computer system 1000 and/or other devices that may be configured to implement and use one or more programmable and collectable probes in applications executing in various runtime environments may include any combination of hardware or software that can perform the indicated functions, including, but not limited to, a computer, personal computer system, desktop computer, laptop, notebook, tablet device, slate device, netbook computer, mainframe computer system, handheld computer, workstation, network computer, camera, set top box, mobile device, network device, internet appliance, PDA, wireless phone, pager, consumer device, video game console, handheld video game device, application server, storage device, peripheral device (such as a switch, modem, or router), or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components described herein may execute in memory on another device and communicate with the illustrated computer system via inter-computer communication. Some or all of the system components or data structures may also be stored (e.g., as instructions or structured data) on a non-transitory computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. As previously noted, various embodiments may further include receiving, sending or storing instructions and/or data implemented in accordance with the foregoing description upon a computer-accessible medium. Accordingly, the techniques described herein may be practiced with other computer system configurations.

The various methods as illustrated in the figures and described herein represent example embodiments of methods for implementing and using one or more programmable and collectable probes in applications executing in various runtime environments. The methods may be implemented in software, hardware, or a combination thereof. In various embodiments, the order of method may be changed, and various elements may be added, reordered, combined, omitted, modified, etc.

Various modifications and changes may be made as would be obvious to a person skilled in the art having the benefit of this disclosure. It is intended that the disclosure embrace all such modifications and changes and, accordingly, the above description to be regarded in an illustrative rather than a restrictive sense.

What is claimed is:

1. A method, comprising:
performing by a computer:
receiving data indicating that a probe is to be removed from an application into which one or more probes have been inserted at respective call sites, wherein the data comprises an identifier of the probe, and wherein each of the one or more probes comprises probe code that is executable to cause the computer to perform one or more functions associated with the probe;
beginning execution of the application;
in response to the execution encountering the probe to be removed from the application, marking the probe for removal without performing the one or more functions associated with the probe;
continuing execution of the application; and
in response to said marking, removing the probe from the application, wherein said removing comprises replacing at least a portion of the probe code for the probe with one or more no operation (NOP) instructions.

2. The method of claim 1, further comprising, subsequent to said removing:
receiving an indication that the probe is to be reactivated;
in response to receiving the indication that the probe is to be reactivated, replacing the one or more NOP instructions with the at least a portion of the probe code for the probe; and
executing the application, wherein said executing comprises executing the at least a portion of the probe code for the probe.

3. The method of claim 1,
wherein two or more probes have been inserted into the application at respective call sites;
wherein the received data comprises a unique identifier of the probe; and
wherein the received data indicates that fewer than all of the two or more probes are to be removed.

4. The method of claim 1, further comprising, in response to the execution encountering another probe, performing the one or more functions associated with the other probe.

5. The method of claim 1, wherein the probe code for each of the one or more probes comprises a call to a respective probe stub, and wherein said removing comprises replacing the call to the respective probe stub for the probe with a no operation (NOP) instruction.

6. The method of claim 1,
wherein the received data indicates that one or more other probes are to be removed from the application;
wherein the data comprises an identifier of each of the one or more other probes; and
wherein said removing comprises replacing at least a portion of the probe code for each of the one or more other probes with one or more no operation (NOP) instructions.

7. The method of claim 1, wherein said receiving comprises, at run time, accessing a file in which the data is recorded, obtaining the data from a memory in which it is stored, or receiving the data from a command line interface or a graphical user interface.

8. The method of claim 1, wherein the one or more functions associated with the probe perform collecting data during execution of the application or profiling a method of the application during execution of the application.

9. The method of claim 1,
wherein said removing is performed by a just-in-time (JIT) compiler; and
wherein the method further comprises, prior to said removing, the JIT compiler determining that the probe has been marked for removal.

10. The method of claim 1,
wherein said removing is performed by a probe collector process; and
wherein the method further comprises, prior to said removing, the probe collector process accessing the application and determining that the probe has been marked for removal.

11. The method of claim 10, wherein said replacing is performed by the probe collector process in conjunction with performance of a memory garbage collection operation.

12. A system, comprising:
one or more processors; and
a memory storing program instructions;
wherein when executed by the one or more processors, the program instructions cause the one or more processors to perform:
receiving data indicating that a probe is to be removed from an application into which one or more probes have been inserted at respective call sites, wherein the data comprises an identifier of the probe, and wherein each of the one or more probes comprises probe code that is executable to cause the computer to perform one or more functions associated with the probe;
beginning execution of the application;
in response to the execution encountering the probe to be removed from the application, marking the probe for removal without performing the one or more functions associated with the probe;
continuing execution of the application; and
in response to said marking, removing the probe from the application, wherein said removing comprises replacing at least a portion of the probe code for the probe with one or more no operation (NOP) instructions.

13. The system of claim 12, wherein when executed by the one or more processors, the program instructions further cause the one or more processors to perform, subsequent to said removing:
receiving an indication that the probe is to be reactivated;
in response to receiving the indication that the probe is to be reactivated, replacing the one or more NOP instructions with the at least a portion of the probe code for the probe; and
executing the application, wherein said executing comprises executing the at least a portion of the probe code for the probe.

14. The system of claim 12, wherein when executed by the one or more processors, the program instructions further cause the one or more processors to perform, in response to the execution encountering another probe, performing the one or more functions associated with the other probe.

15. The system of claim 12, wherein the probe code for each of the one or more probes comprises a call to a respective probe stub, and wherein said removing comprises replacing the call to the respective probe stub for the probe with a no operation (NOP) instruction.

16. The system of claim 12,
wherein said removing is performed by a just-in-time (JIT) compiler or a probe collector process; and
wherein when executed by the one or more processors, the program instructions further cause the one or more processors to perform, prior to said removing, the JIT compiler or probe collector process determining that the probe has been marked for removal.

17. A non-transitory, computer-readable storage medium storing program instructions that when executed on one or more computers cause the one or more computers to perform:
receiving data indicating that a probe is to be removed from an application into which one or more probes have been inserted at respective call sites, wherein the data comprises an identifier of the probe, and wherein each of the one or more probes comprises probe code that is executable to cause the computer to perform one or more functions associated with the probe;
beginning execution of the application;
in response to the execution encountering the probe to be removed from the application, marking the probe for removal without performing the one or more functions associated with the probe;
continuing execution of the application; and
in response to said marking, removing the probe from the application, wherein said removing comprises replacing at least a portion of the probe code for the probe with one or more no operation (NOP) instructions.

18. The non-transitory, computer-readable storage medium of claim 17, wherein when executed on the one or more computers the program instructions further cause the one or more computers to perform, subsequent to said removing:
receiving an indication that the probe is to be reactivated;
in response to receiving the indication that the probe is to be reactivated, replacing the one or more NOP instructions with the at least a portion of the probe code for the probe; and
executing the application, wherein said executing comprises executing the at least a portion of the probe code for the probe.

19. The non-transitory, computer-readable storage medium of claim 17, wherein when executed on the one or more computers the program instructions further cause the one or more computers to perform, in response to the execution encountering another probe, performing the one or more functions associated with the other probe.

20. The non-transitory, computer-readable storage medium of claim 17, wherein the probe code for each of the one or more probes comprises a call to a respective probe stub, and wherein said removing comprises replacing the call to the respective probe stub for the probe with a no operation (NOP) instruction.
